(19) United States
(12) Patent Application Publication
(10) Pub. No.: US 2006/0077243 A1
(43) Pub. Date: Apr. 13, 2006

(54) System and method for ink jet printing of solvent/oil based inks using ink-receptive coatings

(76) Inventor: Paul A. Edwards, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 10/961,541

(22) Filed: Oct. 8, 2004

(51) Int. Cl. B41J 2/01

(52) U.S. Cl. 347/102

(57) ABSTRACT

A system and method for printing an ink jet ink based on solvent, oil, or both solvent and oil in selected areas of nonabsorbent and semi-nonabsorbent substrates includes applying a coating receptive to the solvent- and/or oil-based ink jet ink in the selected areas, for example with printing station having a printing and drying unit for applying the ink-receptive coating in the desired area or areas of the substrate and then drying the coating, and printing an aqueous ink jet ink in the coated area with an ink jet printer. Variable print may be printed with the in jet ink in a high speed process.

### FIELD OF THE INVENTION

The invention relates to systems and methods for ink jet printing, including drop-on-demand (DOD) technologies such as thermal ink jet (TIJ) and piezoelectric ink jet (PIJ) and continuous ink jet (CIJ) printing, using inks containing slow evaporating organic solvents, oils, or both.

### BACKGROUND OF THE INVENTION

Drop-on-demand (“DOD”) ink jet printing has been widely used for desk top printing. DOD ink jet printers can be thermal or piezoelectric. Both types, but particularly piezoelectric ink jet heads, allow printing with greater accuracy of drop placement and hence print quality as compared to continuous ink jet printing. Recently, the speeds of TIJ & PIJ printers has increased significantly. This has allowed DOD ink jet printing to expand into industrial markets, such as printing of packaging, and into graphics applications, such as wide-format billboard and signage printing. DOD printing has better print quality, resolution, and grey scale capability that does CIJ printing.

It is important in high-speed industrial applications for the printing device to be reliable and not to lose jets due to plugging. Single-pass printing (as contrasted to scanning-type printing) is particularly sensitive to missing jets. An increase in the number of heads used might avoid the problem but would be too costly. Consequently, the ink must be formulated so that it will not dry too fast and clog the print heads. Slow evaporating solvents and oils are included in the ink formulations for this purpose.

When it is desirable to use a low-porosity or non-porous substrate, then the printed ink containing slow evaporating solvents and oils cannot dry quickly on the substrate. CIJ inks formulated with organic solvents and/or oils also have this problem. Many substrates useful in industrial applications would require special drying equipment, longer drying times, or higher drying temperatures to dry the printed ink, solutions that have not been commercially acceptable. Radiation-curable inks have been used in this situation, but these inks require special lamps (e.g., lamps emitting ultraviolet light) to cure. The radiation-curable inks, as well as the special lamps, can be very expensive and must be printed at slower speeds to allow adequate exposure to the lamps. Moreover, the radiation curing inks have problems spreading on certain substrates that results in poor print quality.

### SUMMARY OF THE INVENTION

The present invention provides a method of continuous ink jet (CIJ) or drop-on-demand (DOD) ink jet printing over low-porosity or non-porous substrates with ink containing organic solvents and/or oils, in which an ink-receptive coating is applied to an area or areas of the substrate to be printed and ink jet ink is applied in the coated area or areas. The coating absorbs the solvent and/or oil of the printed ink to shorten the apparent dry time of the ink. The ink jet ink may contain a slow-evaporating solvent and/or oil for longer open time and better reliability of the DOD printing device. A greater proportion of slow-evaporating solvent and/or oil can be included in the DOD ink for more reliability than would be possible if printing on the substrate without the ink-receptive coating layer.

The present invention also provides a system for printing organic solvent- and/or oil-based ink jet inks, including printing by CIJ, TIJ, or PIJ, in selected areas of nonabsorbent and semi-nonabsorbent substrates. The system has a press with a printing station for applying an ink-receptive coating that is receptive to organic solvent- and/or oil-based inks to the desired area or areas of the substrate and an ink jet printer positioned to apply a variable print in the coated area. Optionally, a dryer may be used to dry or cure the ink-receptive coating as needed before the ink jet printer, or the coating may dry by air. The coated substrate may pass through further print stations where ink is applied. An “ink receptive coating” is a coating that readily absorbs the organic solvent- and/or oil-based ink. Since the ink is readily absorbed, the drop spread is minimal and the printed substrate can be further handled as though it were dry. The ink-receptive coating contains the ink and the surface is not tacky.

In one embodiment, the invention provides a system for printing nonabsorbent and semi-absorbent substrates, the system including a printing press having at least five stations, one of which is used to apply an ink-receptive coating to the desired area or areas of a substrate. The system further includes an ink jet printer (such as a DOD or CIJ printer) positioned to apply a variable print in the coated area using a solvent-based or oil-based ink.

The present invention provides a method of printing a solvent-based and/or oil-based CIJ, TIJ, or PIJ ink in at least one selected area of a substrate, in which an ink-receptive coating is applied in the selected area before the ink jet ink is printed. In various embodiments, one or more of variable text, numbers, bar codes, or graphics are printed with an solvent- and/or oil-based ink jet ink in the at least one selected area of the substrate. Also in various embodiments, a heater or source of actinic radiation is used to dry or cure the coating before the ink jet ink is printed in the coated area.

The printing method of the present invention can provide substantial improvements in the drying rate of ink jet print (as determined by when the print can be processed by handling, rolling up, and so on), such as 50 to 90 percent. Using the inventive method or system, even nonporous substrates, such as very high gloss stock, metal, coated substrates, and plastics, can be printed with slow-evaporating solvent- and/or oil-based ink jet inks without long drying tracks, slow printing speeds, or costly or inefficient modifications to the press. The print quality is substantially improved, and there is more consistency in print quality between different substrates. Because the coating is only applied in the area to be printed with the waterborne ink jet ink, the finish on the remainder of the substrate is unaffected in appearance.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### BRIEF DESCRIPTION OF THE DRAWINGS

The present invention will become more fully understood from the detailed description and the accompanying drawings, wherein:

FIG. 1 is a block diagram of an embodiment of a system of the invention for web printing;

FIG. 2 is a block diagram of a mail table embodiment of the invention; and

FIG. 3 illustrates an area of a substrate printing using a method of the invention.

### DETAILED DESCRIPTION OF THE PREFERRED EMBODIMENTS

The following description of the preferred embodiment(s) is merely exemplary in nature and is in no way intended to limit the invention, its application, or uses.

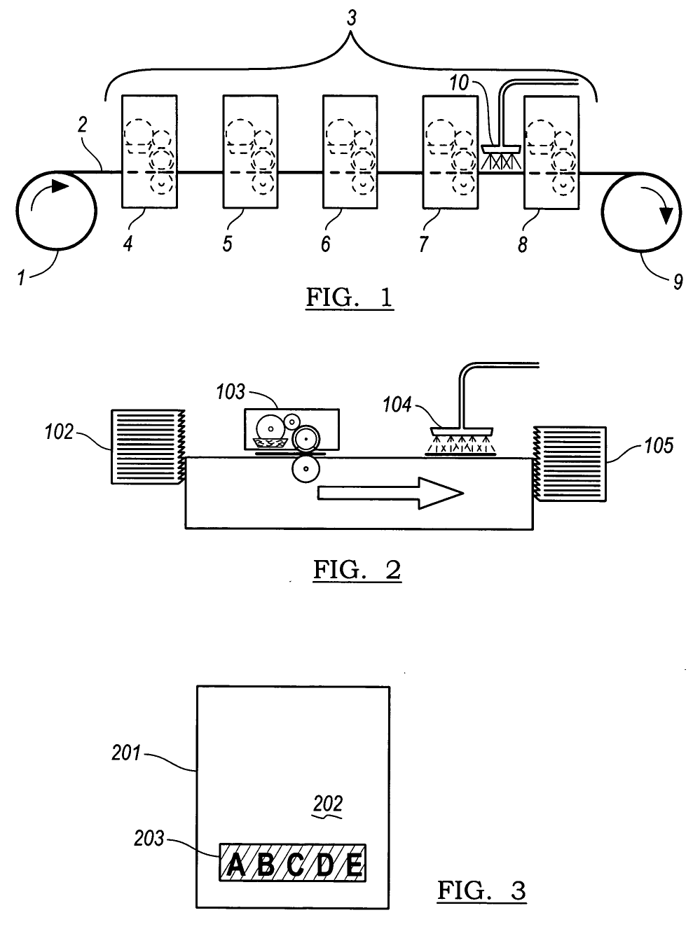

The inventive system and method provide a means of printing solvent- and/or oil-based ink jet ink in selected areas of nonabsorbent and semi-nonabsorbent substrates. The system has a press with a coating station having a printing unit and, optionally, a heat or radiative source for applying an ink-receptive coating, optionally formulated to provide an aesthetically pleasing appearance as explained further below, to the desired area or areas of the substrate and then drying or curing the coating and a CIJ, TIJ, or PIJ printer positioned to apply a variable print in the coated area. Referring first to FIG. 1, a web 2 of a nonabsorbent and semi-nonabsorbent substrate unwinds from roll 1, passes through press 3 having five printing stations 4, 5, 6, 7, and 8 and rolls up on roll 9. Press 3 may, for example, print by flexography or by intaglio or gravure. An ink jet printing unit 10 prints a desired area of the substrate between printing stations 7 and 8.

The ink-receptive coating may be applied using a print station already available on the press and, therefore, no additional equipment must be installed. The press illustrated In FIG. 1 has five print stations, but other presses may have more than five print stations. For example, then, in FIG. 1 one of print stations 4-7 may be selected to apply an ink-receptive coating onto the substrate. The coating is printed onto a specific area, or more than one specific area, on the substrate. If there is at least one additional print station between the print station applying the coating and the CIJ, TIJ, or PIJ printer, the coating may dry sufficiently before it reaches the ink jet print head without heat, or may be dried by a heat source associated with the additional print station or stations. Thus, referring again to FIG. 1, the ink receptive coating may be applied with one of print stations 4, 5, or 6, then dried without heat before reaching ink jet printing unit 10, or the ink receptive coating may be dried by a heat source or cured by a radiative source located after the coating is applied. The applied coating may not need to dry fully before reaching the CIJ, TIJ, or PIJ printhead, so long as it attains sufficient ink receptiveness so that when the surface contacts a roller or other equipment the ink jet print remains acceptable in appearance. The ink-receptive coating may also be applied in print station 7, particularly if the print station includes or is followed by a thermal dryer or if the coating is cured with actinic radiation.

Examples of nonabsorbent or semi-nonabsorbent substrates include, without limitation, high gloss, satin, or coated paper or paperboard and plastic (e.g., polyethylene, polypropylene, vinyl, or polyester), which may be supplied as webs, rolls, or sheets, as well as plastic and metal packaging materials.

The press may be, for example, a flexographic press or gravure press. In various other embodiments, the ink-receptive coating may be applied to the desired area(s) by pad printing, spray printing, or ink jet printing.

The ink-receptive coating composition is selected to be solvent- and/or oil-absorbent. Typical coating compositions include a polymer or resin, preferably one or more film-forming polymers or resins (the “binder”), and absorbent particles. When the amount of absorbent particles in the coatings is sufficiently high to aborsb the desired amount of ink, then the polymer does not need to be particularly receptive to solvents and oil itself, and waterbased polymers and compositions may be used. Examples of suitable polymers and resins include, without limitation, water soluble or dispersible film-forming polymers and/or latex polymers such as poly(vinyl alcohol), poly(vinyl acetate), copolymers of vinyl acetate, hydroxyethyl cellulose, methyl cellulose, carboxy methyl cellulose, starch, gum arabic, polyethylene glycol poly(vinyl pyrrolidone), polyacrylamide, polypropylene glycol, gelatin, and combinations of these. The ink-receptive coating may also be formulated with materials that cure by exposure to actinic radiation, particularly free-radical curing monomers and oligomers and cationically-curing monomers and oligomers. When binder of the coating is also relied on for ink absorbing properties, however, the binder may be selected to provide affinity for a wide range of solvents and/or oils. Suitable examples of such binders include, without limitation, polyketone resins, vinyl acetate copolymers, polyesters having such affinity, vinyl chloride copolymers, and the like.

Examples of absorbent particles that may be used in the ink-receptive coating include, without limitation, highly porous silica, cationic, porous inorganic oxides, particularly silica gels such as silica hydrogels, aerogels, xerogels, cogels, and other inorganic oxides such as alumina, silica/alumina, and titania as well as polymeric absorbents such as crosslinked PVP polymer particles. In general, inorganic oxides having pore volumes of 0.6 cc/g or more are preferred, particularly those having pore volumes of 0.6 to 3.00 cc/g are suitable. Also in general, the average particle size should be in the range of 1 to 20 microns, preferably about 3 to about 12 microns, particularly preferably about 5 to about 8 microns.

To give the ink-receptive coating an aesthetically pleasing appearance, the gloss of the coating may be increased a desired amount and/or the ink-receptive coating may be colored by addition of one or more colorants, which may be selected from dyes and/or pigments. The gloss of the ink-receptive coating may be increased by decreasing the amount of absorbent particles relative to the amount of binder and/or by decreasing the average particle size of the absorbent particles. Decreasing the relative amount or average particle size of the absorbent particles may increase the dry time for the coating if the coating is not dried with a heater or cured by actinic radiation, so selection of a binder having affinity toward the solvent and/or oil in the ink jet ink becomes more important. In such a case, the increase in gloss and dry time may also be balanced to the best advantage for the particular printing equipment and print job. The ink receptive coating may be colored by addition of colorants to obtain a desired color. Suitable examples of colorants that may be employed include, without limitation, titanium dioxide, ink jet grade dyes, and water- and solvent-dispersed, colored pigments. In general, any dye or pigment that could be used in a water or solvent based coating may be employed in that coating.

The porous, absorbent particles may be included at amounts of 0.1 to 80 percent by weight, preferably at least about 25 percent by weight, of the nonvolatile components of the ink-receptive coating composition. Higher amounts of porous, absorbent particles allow the printed surface of the coating to be resistant to blocking after little actual drying of the waterborne ink jet ink. Instead of drying, the ink is absorbed into the porous particles, which prevent smearing and release the water from the ink over time. As the amount of absorbent particles in the coating increases, the coating becomes more matt. Consequently, in various embodiments it may be desirable to limit the amount of absorbent particles to attain a desired coating gloss.

In various embodiments, ink-receptive coating compositions may include other components such as optical brighteners, crosslinking agents such as driers for the polymer or resin, dispersants, lubricants, preservatives, anti-foam surfactants, drop size modifiers, color fastness additives, and so on.

In general, the coating composition is applied at rates of about 2 to about 30 g/m², preferably from about 10 to about 20 g/m². The ink-receptive coating can be applied in the desired area or areas using conventional printing methods such as flexography, gravure, pad printing, spray deposition, and so on. The coating is applied to areas that will receive variable print. Variable print is typically applied to a specific area of print stock, for instance a bar code applied on the bottom or back of packaging, an address applied in a corner on the front of a magazine cover, personalization on a product, or short- or special-run advertising that may be placed anywhere on a product.

The ink receptive coating may be formulated to be curable on exposure to actinic radiation, in which case the printing station may include a source of actinic radiation to which the coating is exposed after application to the substrate. In various embodiments, the print station may include a heater for at least partially drying the applied coating. The applied coating layer can be dried, for example, at room temperature, by hot air drying, heat surface-contact drying, or heat radiation drying. Curable applied coating layers can be cured under appropriate conditions, such as thermally or by exposure to actinic radiation, as mentioned.

The substrate may be printed with repetitive print at other print stations of the press, typically using process colors (e.g., CMYK) for full color print.

The solvent- and/or oil-based ink jet ink may be applied, for example, with single jet or high speed, binary array printer such as Domino A300 and Videojet Printpro, as well as printers based on Hewlett Packard or other TIJ head technology and PIJ head technology from Spectra, Xaar, Epson or others. Typically, the ink jet printer is used to apply variable text, numbers, bar codes, or graphics in the selected areas that have been coated with the ink-receptive coating. For example, a cover of a glossy magazine printed on a conventional web press (flexo or gravure) receives coating in selected areas, which could be over part of the repetitive print or on unprinted areas, at one printing station and variable text such as mailing address, subscription information, and bar codes may be printed with waterborne ink by a continuous ink jet printer. The aesthetically pleasing appearance of the coating lets the coated area or areas blend in with the repetitive print on the rest of the substrate or provides a highlight or contrasting color. The coating may have an amount of gloss which makes it like, or more like, the gloss of the rest of the magazine cover, for example. In another example, the coating may be colored to match an area that receives the coating or to provide a highlighted or contrasting color area for the variable print.

The ink-receptive coating and solvent- and/or oil-based ink jet ink may be applied onto nonabsorbent and semi-nonabsorbent stock that has already been printed. For example, as illustrated in FIG. 2, printed, nonabsorbent or semi-nonabsorbent substrates, for example magazines with glossy covers, are imprinted using a mail table. On one side of the mail table is a stack 102 of magazine cover sheets having nonabsorbent or semi-nonabsorbent surfaces. The sheets are passed one by one through print station 103, which may be, for example, a flexographic print station or a gravure print station. Print station 103 applies an ink-receptive coating in one or more areas or “knock outs” on the sheet. Print station 103 includes a heater or other unit to at least partially dry the applied coating, after which the sheet passes to an ink jet print head 104. Ink jet printhead 104 applies a variable print using a solvent- and/or oil-based ink. The printed sheet may then pass to a heater [not shown] or actinic radiation source [not shown], as appropriate for the particular ink jet ink selected. The sheet then passes to stack 105 of sheets printed with variable print. A mail table typically enables medium or high speed, off-line printing of variable text, while variable text can be applied at very high speed in an in-line process such as that discussed with reference to FIG. 1.

FIG. 3 illustrates a portion of a sheet printed with variable print. Sheet section 201 has an area 202 of full-color, glossy print and a “knock out” area 203 with an ink-receptive coating. Inside the “knock out” area 203 is representative variable text printed with an solvent- and/or oil-based ink jet ink. The coating in the “knock-out” area 203 may have a gloss and/or color similar to a part of area 202, and/or a color that contrasts to the area around the knock-out area 203.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of printing a solvent- and/or oil-based ink jet ink on at least one selected area of a nonabsorbent and semi-nonabsorbent substrate, comprising steps of:
applying an ink-receptive coating to the selected area of the substrate that is receptive toward the solvent- and/or oil-based ink,
at least partially drying the coating,
and printing the solvent- and/or oil-based ink jet ink on the coating.

2. A method according to claim 1, wherein the ink-receptive coating is applied using a flexographic printing station, a gravure printing station, or pad printing.

3. A method according to claim 1, wherein the solvent- and/or oil-based ink jet ink is printed with a drop-on-demand ink jet printer.

4. A method according to claim 1, wherein the coating is at least partially dried with heat.

5. A method according to claim 1, wherein the coating is cured by exposure to actinic radiation or thermally or both by exposure to actinic radiation and thermally.

6. A method according to claim 1, wherein the ink-receptive coating has a semi-gloss or glossy appearance.

7. A method according to claim 1, wherein the ink-receptive coating comprises a colorant.

8. A method of printing variable print in selected areas on a nonabsorbent or semi-nonabsorbent web or roll of a substrate, comprising steps of:
applying to the selected areas an ink-receptive coating that is receptive to a solvent- and/or oil-based ink jet ink,
at least partially drying the coating,
and printing a solvent- and/or oil-based ink jet ink on the coating in variable print.

9. A method according to claim 8, wherein the ink-receptive coating is applied using a print station of a web flexographic or gravure press or by pad printing.

10. A method according to claim 9, wherein repetitive print is applied at one or more additional print stations of the press.

11. A method according to claim 9, wherein the print station includes a thermal dryer.

12. A method according to claim 8, wherein, in the variable print is selected from the group consisting of variable text, variable numbers, variable bar codes, and variable graphics.

13. A method according to claim 8, wherein the ink-receptive coating has a semi-gloss or glossy appearance.

14. A method according to claim 8, wherein the ink-receptive coating comprises a colorant.

15. A method of continuously printing variable print in selected areas on sheets of nonabsorbent or semi-nonabsorbent substrate, comprising steps of:
applying to the selected area on each sheet an ink-receptive coating that is receptive to solvent- and/or oil-based ink;
at least partially drying the coating; and
printing a solvent- and/or oil-based ink jet ink in variable print in the area with an ink jet printer.

16. A method according to claim 15, wherein the ink-receptive coating is applied using a print station of a press.

17. A method according to claim 16, wherein repetitive print is applied at one or more additional print stations of the press.

18. A method according to claim 16, wherein the print station includes a thermal dryer.

19. A method according to claim 15, wherein the variable print is selected from the group consisting of variable text, variable numbers, variable bar codes, and variable graphics.

20. A method according to claim 15, wherein the sheets of nonabsorbent or semi-nonabsorbent substrate are printed before the ink-receptive coating is applied.

21. A method according to claim 15, wherein the method is carried out using a mail table.

22. A method according to claim 21, wherein the applied coating is at least partially dried or cured before printing the solvent- and/or oil-based ink jet ink.

23. A method of printing variable text on nonabsorbent or semi-nonabsorbent substrate using a printing press having multiple print stations, comprising steps of:
applying repetitive print with one to less than all of the print stations;
applying an ink-receptive coating in a selected area of the substrate with one of the print stations;
at least partially drying or curing the ink-receptive coating; and
applying a solvent- and/or oil-based ink in the area of the ink receptive coating to form a variable print using an ink jet printer.

24. A method according to claim 23, wherein the coating is applied over a part of the substrate having repetitive print.

25. A method according to claim 23, wherein the coating has a glossy or semi-gloss appearance.

26. A method according to claim 23, wherein the coating comprises a polymer or resin with affinity toward solvent and/or oil and absorbent particles.

27. A method according to claim 23, wherein the coating is cured by exposure to actinic radiation.

28. A method according to claim 23, wherein the coating is matt and translucent.

29. A method according to claim 23, wherein the coating comprises a member selected from the group consisting of highly porous silica, silica gels, alumina, silica/alumina, titania, and combinations thereof.

30. A method according to claim 23, wherein the coating comprises an inorganic oxide having a pore volume of at least about 0.6 cc/g,

31. A method according to claim 23, wherein a print station is located between the print station applying the ink-receptive coating and the ink jet printer.

32. A system for printing variable text in a selected area of a nonabsorbent or semi-nonabsorbent substrate, comprising
a press with a printing station having a printing unit that applies an ink-receptive coating to the selected area and
an ink jet printer positioned to apply a variable print in the coated area using a solvent- and/or oil-based ink.

33. A system according to claim 32, wherein the press is a flexographic press or a gravure press.

34. A system according to claim 32, wherein the press has at least one additional printing station.

35. A system according to claim 32, wherein the printing station having a printing unit that applies an ink-receptive coating comprises a heat or radiative source for drying or curing or both drying and curing the applied coating.

36. A mail table, comprising
a print station that applies a coating receptive to a solvent- and/or oil-based ink jet ink in one or more areas of a nonabsorbent or semi-nonabsorbent, printed sheet fed onto the mail table,
a heater that at least partially dries the applied coating or a source of actinic radiation that at least partially cures the applied coating, and
an ink jet print head that applies a variable print to the one or more areas using a solvent- and/or oil-based ink.
